(19) United States
(12) Patent Application Publication
(10) Pub. No.: US 2005/0011320 A1
(43) Pub. Date: Jan. 20, 2005

(54) Wrench having identification function

(76) Inventor: Chih-Ching Hsien, Taichung (TW)

Correspondence Address: Chih-Ching Hsien, 58, MA YUAN WEST ST., TAICHUNG, TW

(21) Appl. No.: 10/623,314

(22) Filed: Jul. 17, 2003

(51) Int. Cl. B25B 13/58

(52) U.S. Cl. 81/180.1

(57) ABSTRACT

A wrench includes a handle portion having a driving head having a peripheral wall provided with a plurality of protruding resting portions and a plurality of concave portions connected between the resting portions. The peripheral wall of the driving head is provided with three protruding portions each mounted in one of the concave portions. Thus, by indication of the larger spacing and the color of the three colored protruding portions of the driving head, the user can easily and quickly identify if the nut can or cannot pass through the driving head of the wrench, thereby facilitating the user employing the wrench to operate the nut.

### BACKGROUND OF THE INVENTION

1. Field of the Invention

The present invention relates to a wrench having an identification function, and more particularly to a wrench, wherein the user can easily and quickly identify if the nut can or cannot pass through the driving head of the wrench, thereby facilitating the user employing the wrench to operate the nut.

2. Description of the Related Art

A conventional wrench in accordance with the prior art shown in FIG. 12 comprises a handle 4 having an end provided with a driving head 40 formed with an operation hole 42 to position a nut 44, so that the driving head 40 can be rotated to rotate the nut 44. However, the nut 44 is retained in the operation hole 42 of the driving head 40 rigidly, so that the nut 44 easily slips from the driving head 40 during operation of the wrench.

Another conventional wrench in accordance with the prior art shown in FIGS. 13 and 14 comprises a driving head 1 formed with an annular groove 2, and a snap ring 3 mounted in the annular groove 2 of the driving head 1. Thus, the snap ring 3 is rested on the nut (not shown) to prevent the nut from slipping from the driving head 1 during operation of the wrench.

### SUMMARY OF THE INVENTION

The primary objective of the present invention is to provide a wrench, wherein by indication of the larger spacing and the color of the three colored protruding portions of the driving head, the user can easily and quickly identify if the nut can or cannot pass through the driving head of the wrench, thereby facilitating the user employing the wrench to operate the nut.

Another objective of the present invention is to provide a wrench, wherein when each of the three colored protruding portions of the driving head is aligned with one of the six angled corners of the nut, the nut cannot pass through the driving head to prevent the nut from slipping from the driving head during operation of the wrench.

A further objective of the present invention is to provide a wrench, wherein when each of the three colored protruding portions of the driving head is aligned with one of the six faces of the nut, the nut can pass through the driving head of the wrench easily and conveniently.

In accordance with the present invention, there is provided a wrench, comprising a handle portion having an end formed with a driving head, wherein:
the driving head of the handle portion has a peripheral wall provided with a plurality of protruding resting portions and a plurality of concave portions connected between the resting portions; and
the peripheral wall of the driving head of the handle portion is provided with three protruding portions each mounted in an end of one of the concave portions.

Further benefits and advantages of the present invention will become apparent after a careful reading of the detailed description with appropriate reference to the accompanying drawings.

### BRIEF DESCRIPTION OF THE DRAWINGS

FIG. 1 is a partially perspective cross-sectional view of a wrench in accordance with the preferred embodiment of the present invention;

FIG. 2 is a partially enlarged view of the wrench as shown in FIG. 1;

FIG. 2A is a partially enlarged view of the wrench as shown in FIG. 1;

FIG. 3 is a top plan view of the wrench as shown in FIG. 1;

FIG. 4 is a side plan partially cross-sectional view of the wrench as shown in FIG. 1;

FIG. 5 is a side plan partially cross-sectional operational view of the wrench as shown in FIG. 1;

FIG. 5A is an operational view of the wrench as shown in FIG. 5;

FIG. 5B is a partially cut-away top plan view of the wrench as shown in FIG. 5A;

FIG. 5C is a partially enlarged view of the wrench as shown in FIG. 5A;

FIG. 5D is an operational view of the wrench as shown in FIG. 5;

FIG. 5E is a partially cut-away top plan view of the wrench as shown in FIG. 5D;

FIG. 5F is a partially enlarged view of the wrench as shown in FIG. 5E;

FIG. 6 is an operational view of the wrench as shown in FIG. 1;

FIG. 7 is an operational view of the wrench as shown in FIG. 1;

FIG. 8 is a top plan view of a wrench in accordance with another embodiment of the present invention;

FIG. 9 is a side plan partially cross-sectional view of the wrench as shown in FIG. 8;

FIG. 10 is a perspective view of a wrench in accordance with another embodiment of the present invention;

FIG. 11 is a top plan view of the wrench as shown in FIG. 10;

FIG. 12 is a side plan partially cross-sectional operational view of a conventional wrench in accordance with the prior art;

FIG. 13 is an exploded perspective view of another conventional wrench in accordance with the prior art; and

FIG. 14 is a perspective assembly view of another conventional wrench as shown in FIG. 13.

### DETAILED DESCRIPTION OF THE INVENTION

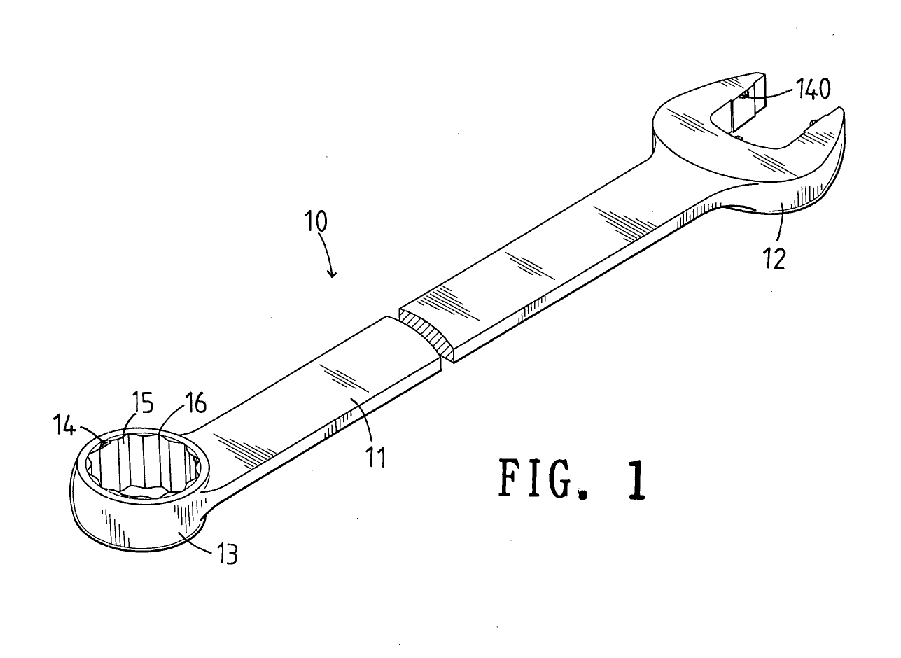

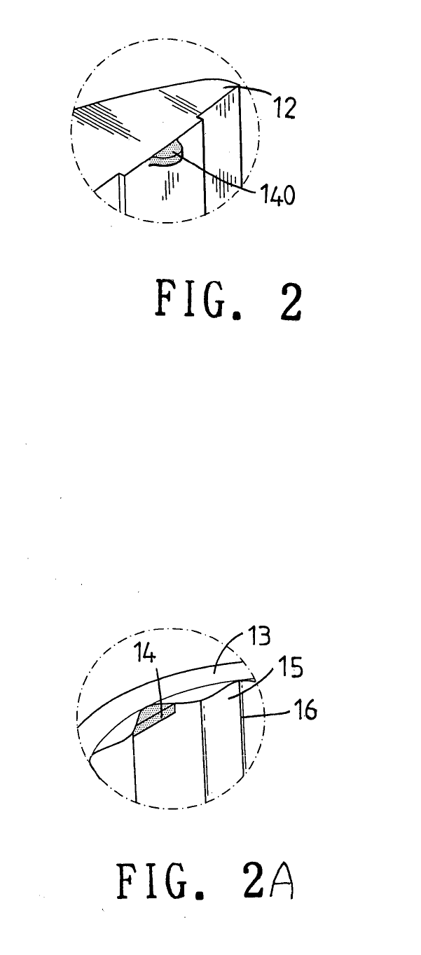

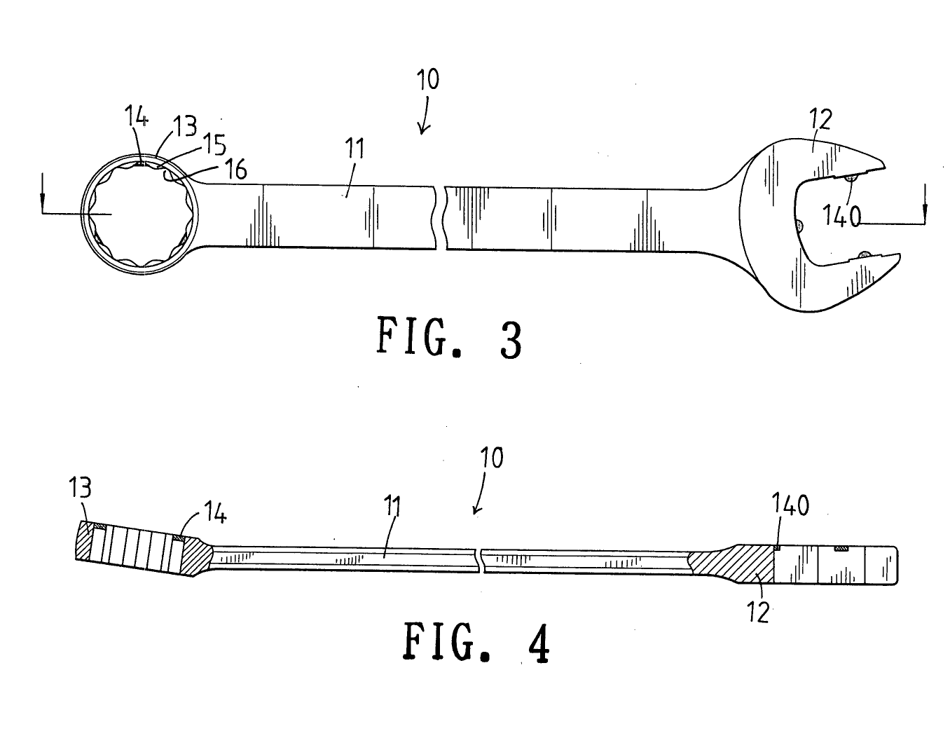

Referring to the drawings and initially to FIGS. 1-4, a wrench 10 in 20 accordance with the preferred embodiment of the present invention comprises a handle portion 11 having a first end formed with an opened driving head 12 and a second end formed with a closed driving head 13.

The opened driving head 12 of the handle portion 11 has a periphery provided with three colored protruding portions 140. Preferably, the three colored protruding portions 140 of the opened driving head 12 have colors different from each other. Preferably, each of the three colored protruding portions 140 of the opened driving head 12 has a semi-circular shape.

The closed driving head 13 of the handle portion 11 has an inner wall provided with a plurality of protruding resting portions 15 and a plurality of concave portions 16 connected between the resting portions 15. Preferably, each of the resting portions 15 is protruded inward toward a center of the closed driving head 13 of the handle portion 11.

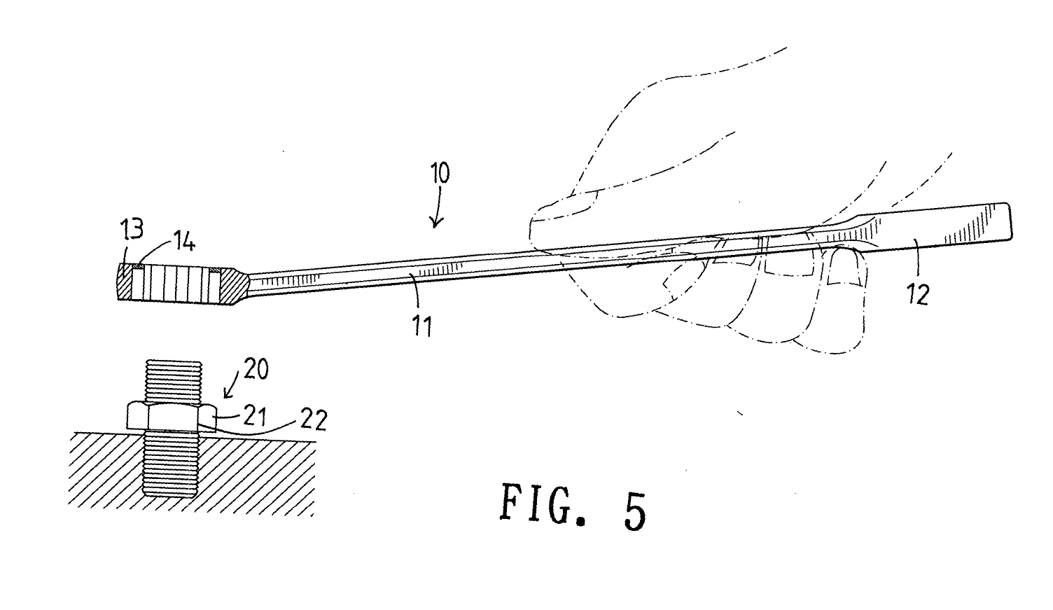

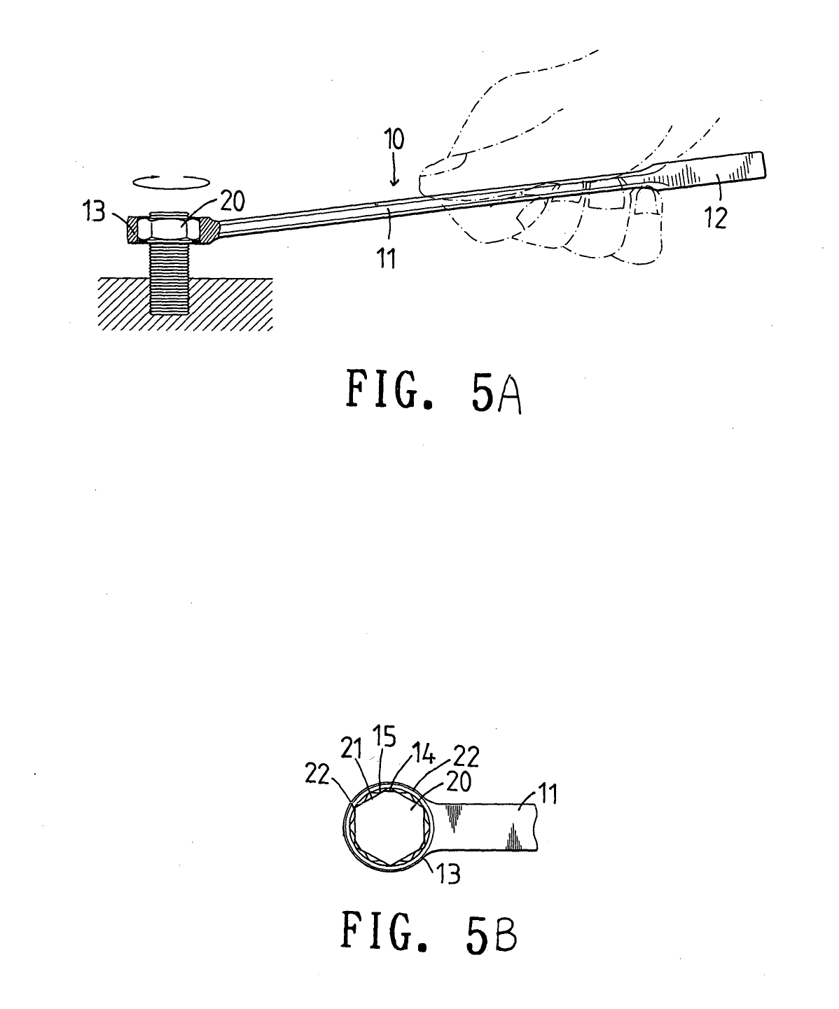

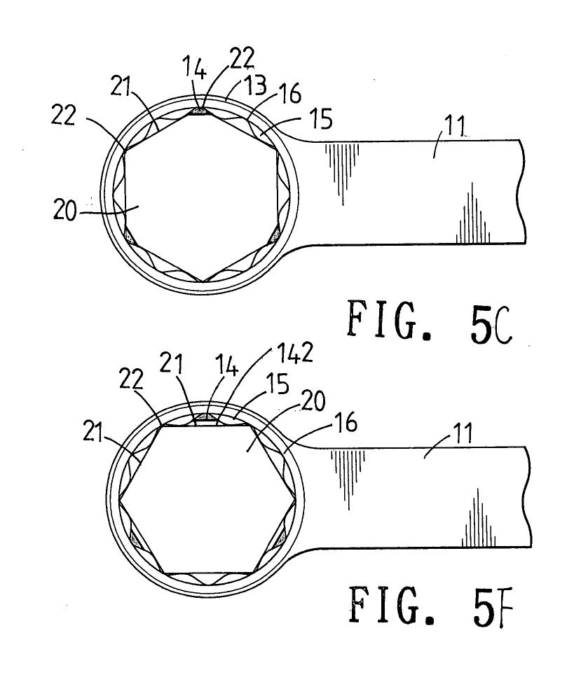

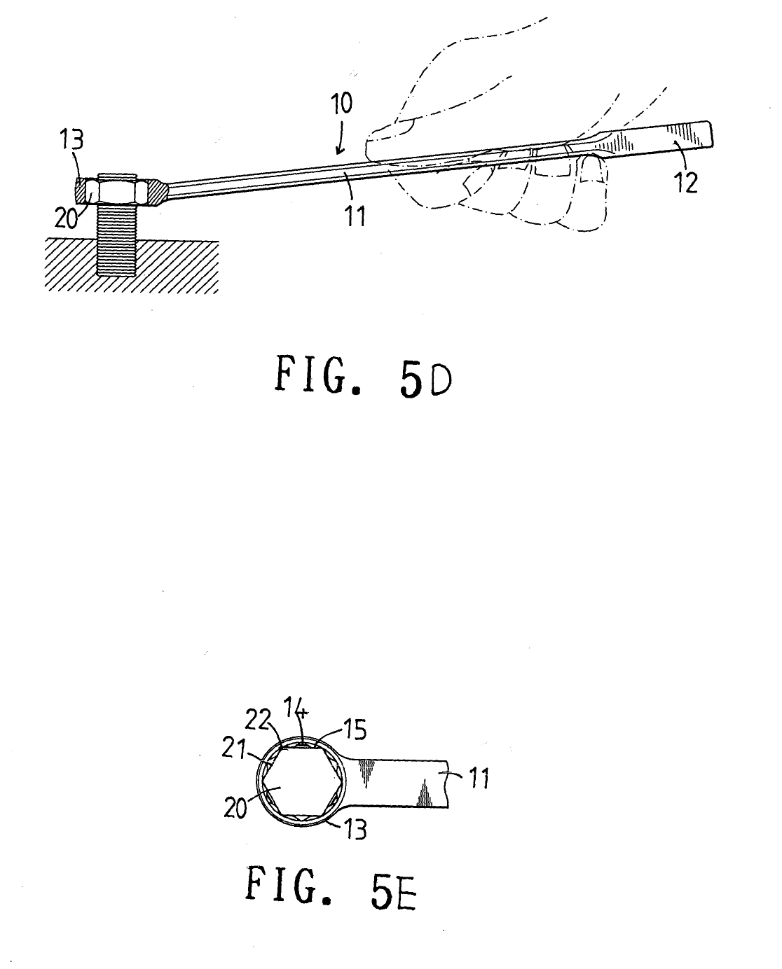

In addition, the inner wall of the closed driving head 13 of the handle portion 11 is provided with three colored protruding portions 14. Preferably, each of the three colored protruding portions 14 of the closed driving head 13 is mounted in an end of one of the concave portions 16. Preferably, the three colored protruding portions 14 of the closed driving head 13 have colors different from each other. Preferably, each of the three colored protruding portions 14 of the closed driving head 13 has a triangular shape. Preferably, the three colored protruding portions 14 of the closed driving head 13 are equally spaced from each other. In addition, a gap 142 (see FIG. 5F) is formed between each of the three colored protruding portions 14 of the closed driving head 13 and the respective concave portion 16.

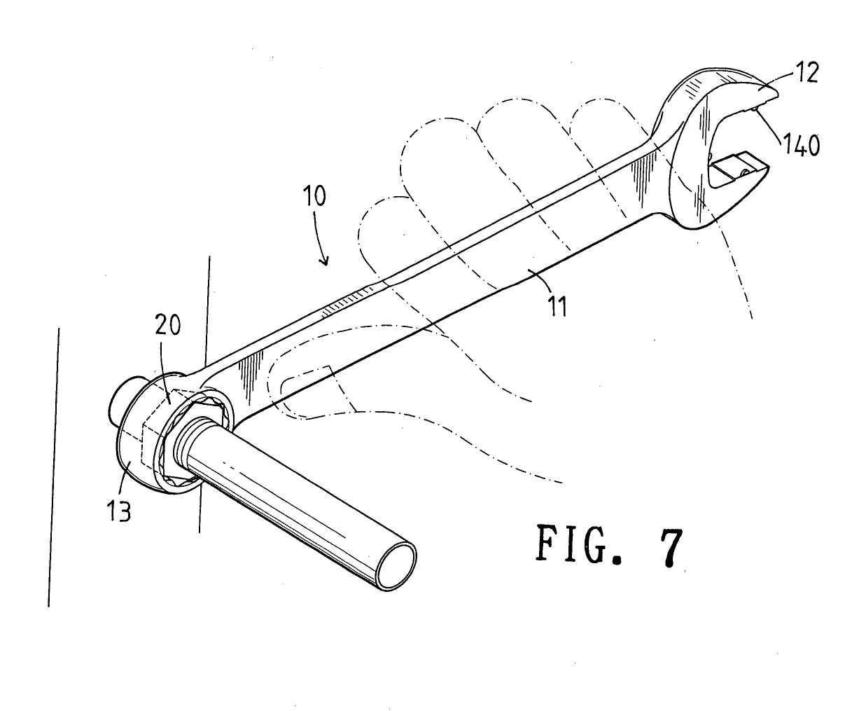

In operation, referring to FIGS. 5-7 with reference to FIGS. 1-4, the closed driving head 13 of the handle portion 11 is mounted on a nut 20 as shown in FIGS. 5 and 5A, with the resting portions 15 being rested on the six faces 21 of the nut 20 and with each of the three colored protruding portions 14 of the closed driving head 13 being aligned with and rested on one of the six angled corners 22 of the nut 20 as shown in FIGS. 5B, 5C and 7. Thus, the three colored protruding portions 14 of the closed driving head 13 are rested on three of the six angled corners 22 of the nut 20, so that the nut 20 is retained by the closed driving head 13 to prevent the nut 20 from passing through and slipping from the closed driving head 13 during operation of the wrench 10.

Alternatively, the closed driving head 13 of the handle portion 11 is mounted on the nut 20 as shown in FIG. 5D, with each of the three colored protruding portions 14 of the closed driving head 13 being aligned with one of the six faces 21 of the nut 20 as shown in FIGS. 5E and 5F. At this time, a gap 142 (see FIG. 5F) is formed between each of the three colored protruding portions 14 of the closed driving head 13 and the respective concave portion 16. Thus, the six faces 21 of the nut 20 can pass through the three colored protruding portions 14 of the closed driving head 13, so that the nut 20 can pass through the closed driving head 13 of the wrench 10 easily and conveniently.

Accordingly, when each of the three colored protruding portions 14 of the closed driving head 13 is aligned with one of the six angled corners 22 of the nut 20 as shown in FIGS. 5C and 7, the nut 20 can be retained by the closed driving head 13 to prevent the nut 20 from slipping from the closed driving head 13 during operation of the wrench 10. In addition, when each of the three colored protruding portions 14 of the closed driving head 13 is aligned with one of the six faces 21 of the nut 20 as shown in FIGS. 5E and 5F, the nut 20 can pass through the closed driving head 13 of the wrench 10 easily and conveniently. Further, by indication of the larger spacing and the color of the three colored protruding portions 14 of the closed driving head 13, the user can easily and quickly identify if the colored protruding portions 14 of the closed driving head 13 are aligned with the angled corners 22 of the nut 20 (the nut 20 cannot pass through the closed driving head 13 of the wrench 10) or the faces 21 of the nut 20 (the nut 20 can pass through the closed driving head 13 of the wrench 10), thereby facilitating the user employing the wrench 10 to operate the nut 20.

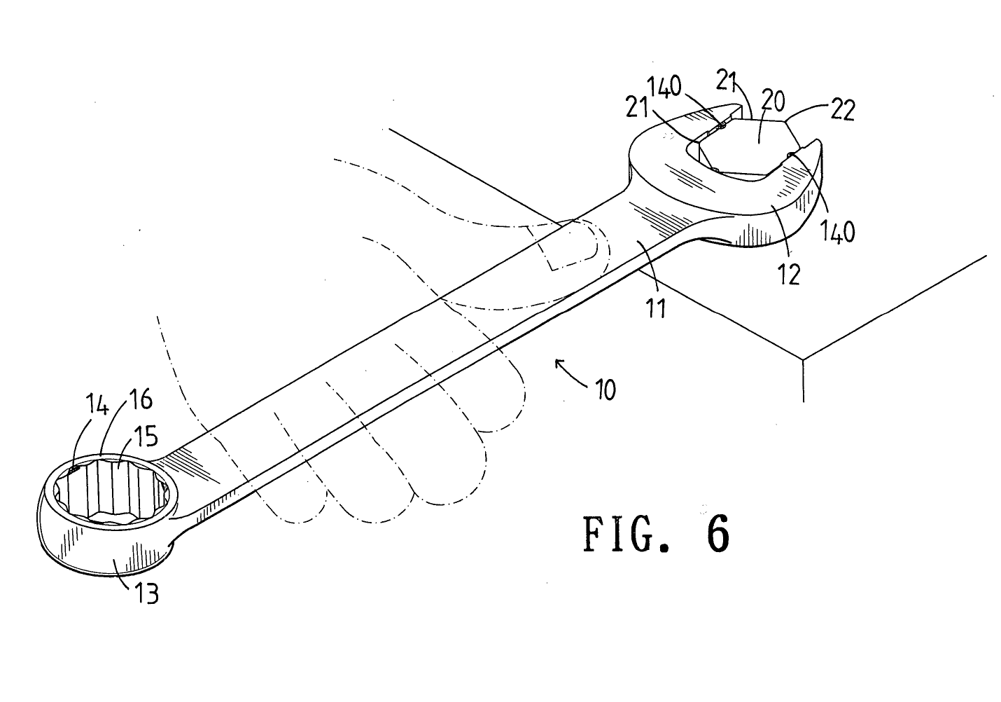

As shown in FIG. 6, the opened driving head 12 of the handle portion 11 is mounted on the nut 20, with each of the three colored protruding portions 140 of the opened driving head 12 being aligned with and rested on one of the six faces 21 of the nut 20. Thus, the three colored protruding portions 140 of the opened driving head 12 are rested on three of the six faces 21 of the nut 20, so that the nut 20 is retained by the opened driving head 12 to prevent the nut 20 from passing through and slipping from the opened driving head 12 during operation of the wrench 10.

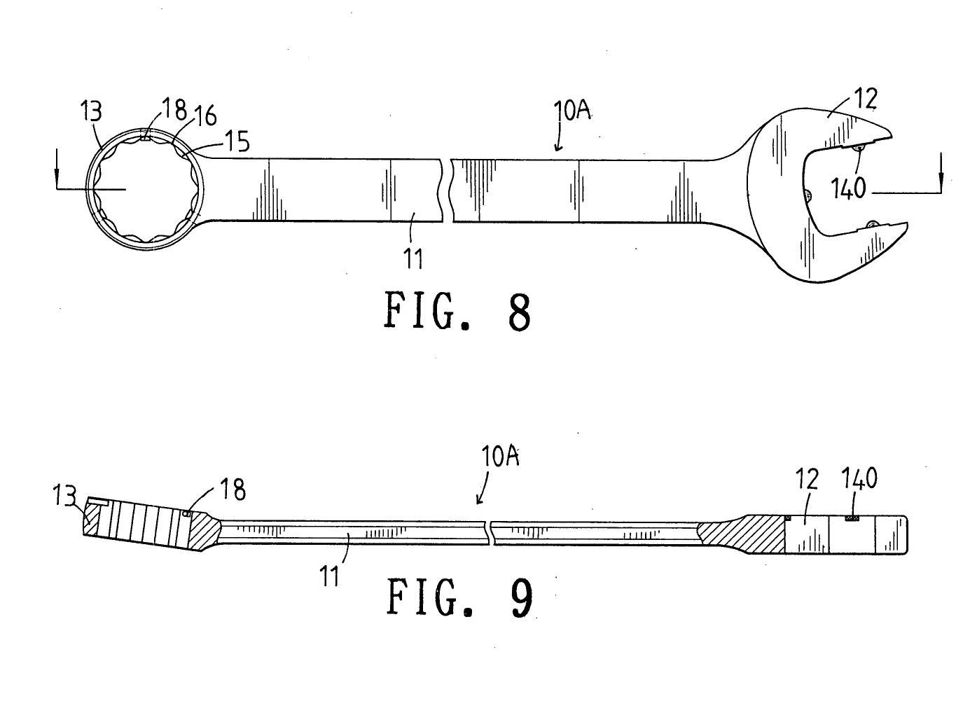

Referring to FIGS. 8 and 9, a wrench 10A in accordance with another embodiment of the present invention is shown, wherein the inner wall of the closed driving head 13 of the handle portion 11 is provided with three protruding positioning pins 18 each mounted in an end of one of the concave portions 16.

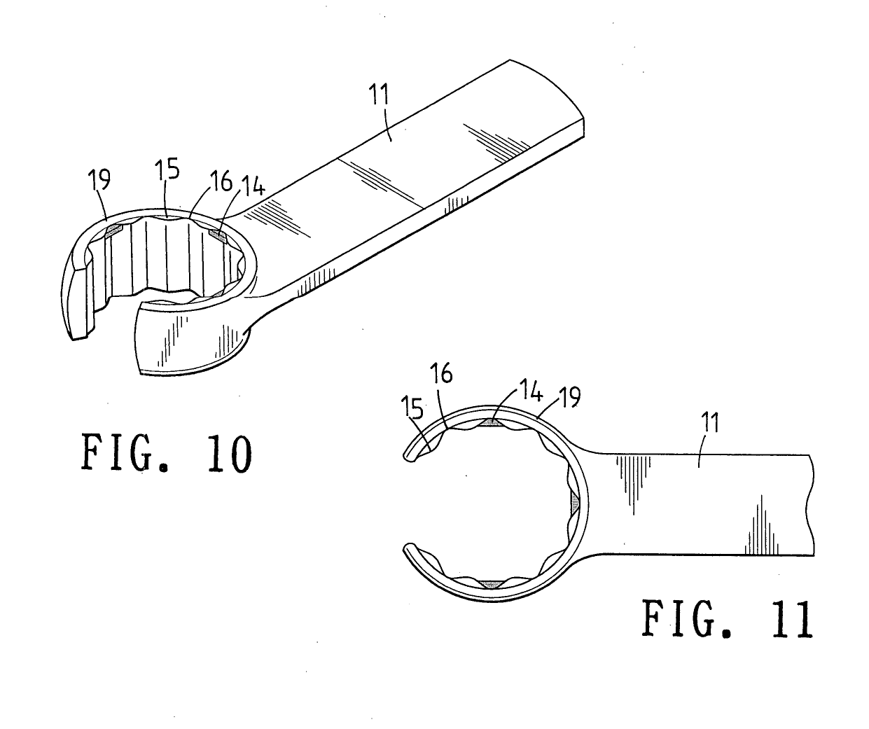

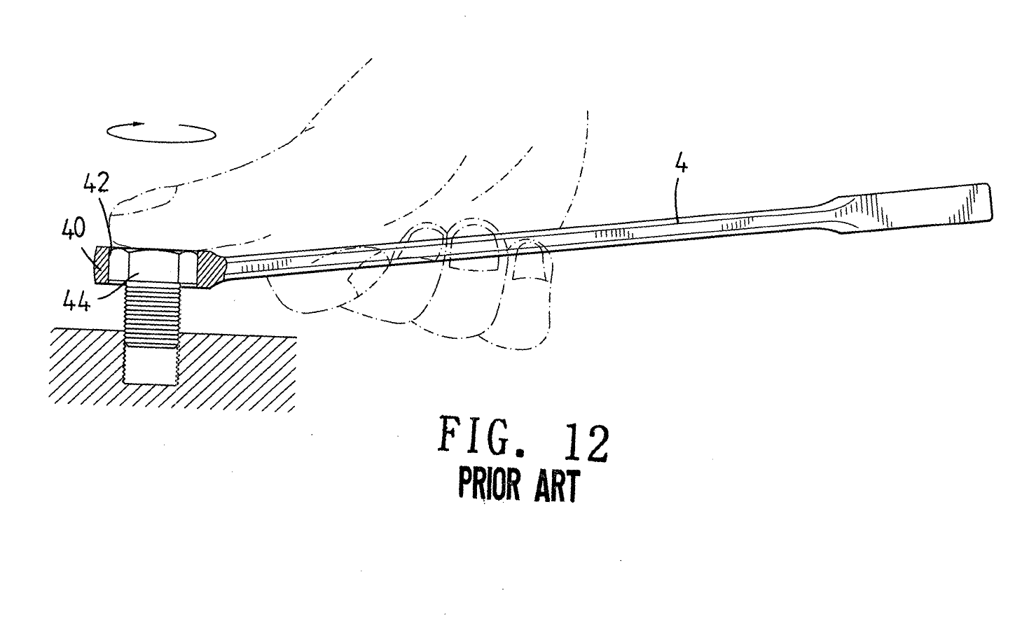

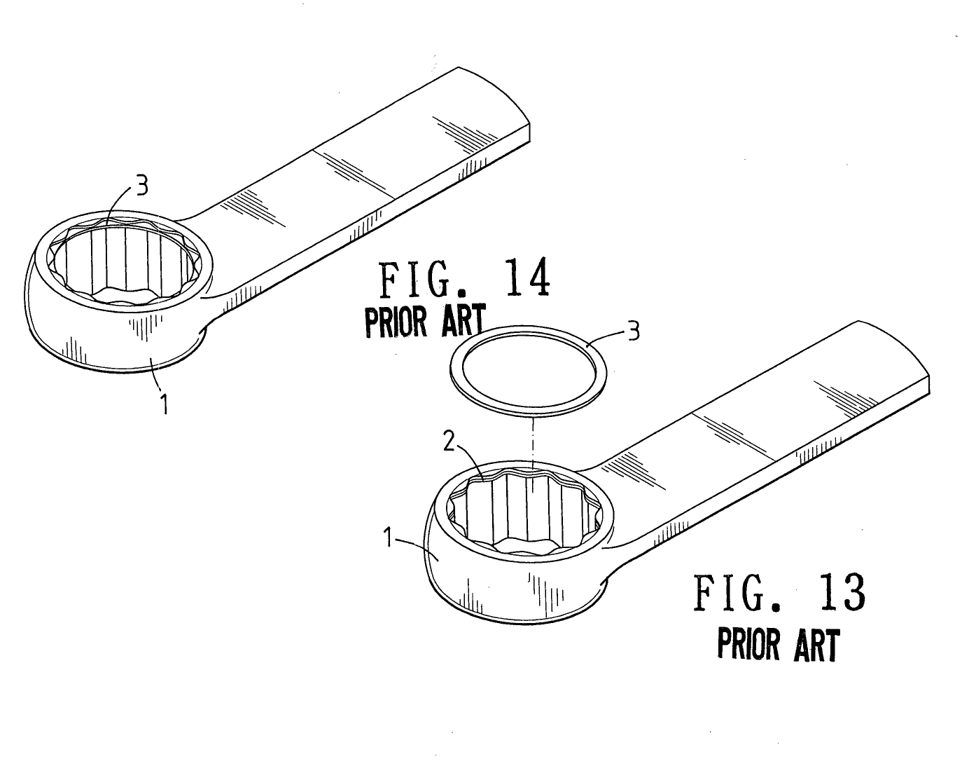

Referring to FIGS. 10 and 11, a wrench in accordance with another embodiment of the present invention is shown, wherein the handle portion 11 has a second end formed with an opened driving head 19.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wrench, comprising a handle portion having an end formed with a driving head, wherein:
the driving head of the handle portion has a peripheral wall provided with a plurality of protruding resting portions and a plurality of concave portions connected between the resting portions;
the peripheral wall of the driving head of the handle portion is provided with three protruding portions each mounted in an end of one of the concave portions;
the driving head is mounted on a nut;
the resting portions of the driving head are rested on six faces of the nut;
the three protruding portions have different colors and have larger spaced distance so as to facilitate a user identifying if the nut passes through the driving head or is stopped by the three protruding portions of the driving head.

2. The wrench in accordance with claim 1, wherein each of the resting portions of the driving head is protruded inward toward a center of the driving head of the handle portion.

3. (canceled)

4. The wrench in accordance with claim 1, wherein each of the three protruding portions of the driving head has a triangular shape.

5. The wrench in accordance with claim 1, wherein each of the three protruding portions of the driving head has a semi-circular shape, each of the resting portions of the driving head has an arc-shaped shape, and each of the concave portions of the driving head has an arc-shaped shape.

6. The wrench in accordance with claim 1, wherein the three protruding portions of the driving head are equally spaced from each other to form an equilateral triangle.

7. The wrench in accordance with claim 1, wherein a linear gap is formed between each of the three protruding portions and the respective concave portion.

8. (canceled)

9. The wrench in accordance with claim 1, wherein each of the three protruding portions of the driving head is aligned with and rested on one of six angled corners of the nut, so that the nut is retained by the driving head to prevent the nut from passing through and slipping from the driving head during operation of the wrench.

10. The wrench in accordance with claim 1, wherein each of the three protruding portions of the driving head is aligned with one of six faces of the nut, so that the six faces of the nut can pass through the three protruding portions of the driving head and the nut can pass through the driving head of the wrench.

11. The wrench in accordance with claim 1, wherein each of the three protruding portions of the driving head is aligned with and rested on one of six faces of the nut, so that the nut is retained by the driving head.

12. The wrench in accordance with claim 1, wherein the driving head is a substantially C-shaped opened driving head.

13. The wrench in accordance with claim 1, wherein the driving head is a closed driving head.

14. The wrench in accordance with claim 1, wherein the driving head is provided with twelve resting portions and twelve respective concave portions, and each of the three protruding portions is equally located between four respective concave portions.

15. The wrench in accordance with claim 1, wherein the three protruding portions form a triangular shape.
